(19) United States
(12) Patent Application Publication
(10) Pub. No.: US 2007/0004384 A1
(43) Pub. Date: Jan. 4, 2007

(54) Method and apparatus for providing personalized audio content delivery during telephony hold

(76) Inventor: Vinod Anupam, Bridgewater, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/169,968

(22) Filed: Jun. 29, 2005

(51) Int. Cl. H04M 3/42

(52) U.S. Cl. 455/414.1

(57) ABSTRACT

A method and apparatus provides personalized audio content delivery to a telephone user who is placed on hold. A server in the telephone network keeps track of a call, and then notices when a party is placed on hold. In response, the server switches the call to an application server that maintains user profiles. A user profile may have been earlier established by a given user to specify the type of content he or she is interested in listening to, such as, for example, relevant weather information, traffic reports, news updates, etc. The application server may also support user interaction, thereby allowing a given user to dynamically choose the content, or to navigate through available options. When the call is taken off hold, the server in the network notices this fact and may, for example, notify the user who can then return to the call.

### FIELD OF THE INVENTION

The present invention relates generally to the field of telephony service features and more particularly to a method and apparatus for providing personalized audio content delivery to a telephone user who is placed on hold.

### BACKGROUND OF THE INVENTION

As is well known, the “hold” feature in conventional telephony allows one party in a telephone conversation to temporarily suspend the conversation while performing some other task. This task may, for example, involve looking up some information in an information source, or may possibly even involve use of the telephone itself, such as, for example, to call someone else to ask a question. Importantly, the time on hold can be open-ended, although social protocol dictates that the delay in getting back should not be inordinate.

Depending on the capabilities of the holding-party's telephone system and the intervening network, the held party invariably hears either “silence” (i.e., nothing at all), or, in some cases, music, news, advertisements, etc. Specifically, when the holding party signals to the telephone system an intent to place the call on hold (e.g., by pushing a “hold” button on his or her telephone), the local telecommunications “switch” notices this request, and places the call on hold within the network. In particular, the network most typically stops sending audio from the held party to the holding party, and instead, it channels to the held party either nothing (i.e., silence), or alternatively, some predefined content (e.g., a marketing message, a radio station, pre-specified music, etc.). The held party typically listens (e.g., waits unproductively) for the holding party to take the call off hold (and to announce that he or she is back on the call), and then the conversation can continue. In any event, it is often the case that the held party has been unable to make productive use of his or her time while waiting for the holding party to take the call off hold.

### SUMMARY OF THE INVENTION

In accordance with the principles of the present invention, I have recognized that it would be far preferable for a party placed on hold to be able to listen to (and possibly interact with) an audio content of his or her choosing while the call is on hold. In this manner, a user placed on hold can make productive use of his or her time, rather than merely waiting unproductively for the party who placed the call on hold to return. As such, in accordance with the principles of the present invention, a method and apparatus provides personalized audio content delivery to a telephone user who is placed on hold. Such personalized audio content delivery to a telephone user on hold will be referred to herein as the “Smart Hold” feature.

In particular, in accordance with one illustrative embodiment of the present invention, a server in the telephone network advantageously keeps track of a call, and then notices when a party is placed on hold. In response, the server switches the call to an application server that advantageously maintains user profiles. For example, a user profile may have been earlier established by a given user to specify the type of content he or she is interested in listening to, such as, for example, relevant weather information, traffic reports, news updates, etc. The application server (“app-server”) may also support user interaction, thereby allowing a given user to dynamically choose the content, or to navigate through available options. When the call is taken off hold, the server in the network advantageously notices this fact and may, for example, notify the user who can then return to the call.

### BRIEF DESCRIPTION OF THE DRAWINGS

FIG. 1 shows an illustrative telephony network for realizing an illustrative embodiment of the present invention.

FIG. 2 shows an illustrative Voice-over-IP (Internet Protocol) communications network for realizing an alternative illustrative embodiment of the present invention.

### DETAILED DESCRIPTION OF THE ILLUSTRATIVE EMBODIMENTS

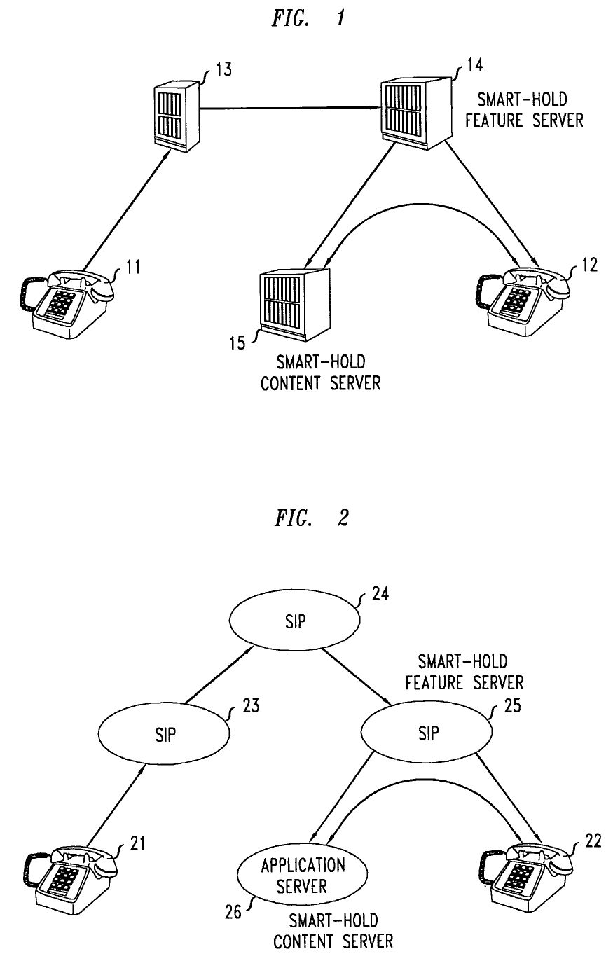

FIG. 1 shows an illustrative telephony network for realizing an illustrative embodiment of the present invention. The illustrative network shown in the figure comprises telephones 11 and 12, servers 13 and 14, which may, for example, comprise conventional telecommunications switches, and Smart Hold Content server 15, which comprises an application server and may, for example, hold various telecommunications feature specific content. Specifically, with reference to FIG. 1, the following process may be employed to advantageously effectuate the illustrative embodiment of the present invention.

First, a user of telephone 11 (hereinafter, the “holding party”), who wishes to place the call on hold, tells the other party, a user of telephone 12 (hereinafter, the “held party”), that he is going to place the call on hold. The user that wants to initiate the hold (i.e., the user of telephone 11 or the holding party) presses the “Hold” button on telephone 11 (or, alternatively, presses an appropriate key sequence on telephone 11) to effectuate the hold. This advantageously signals to server 13 that the user of telephone 11 wishes to place the current call on hold.

Next, server 13 (i.e., the server closest to the holding party) signals into the network that the call is to be placed on hold. This signaling makes its way in particular to server 14 (i.e., the server closest to the held party), which may, for example, notify the held party (i.e., the user of telephone 12) that the call is being placed on hold.

In accordance with the principles of the present invention, and specifically in accordance with the illustrative embodiment thereof, one of the servers in the network “along the way” (e.g., in the network path from the holding party to the held party) initiates a call to Smart Hold Content server 15. The server which initiates this call may, for example, be server 13 (i.e., the server closest to the holding party), server 14 (i.e., the server closest to the held party), or, in illustrative networks in which there are additional intermediate servers between the server closest to the holding party and the server closest to the held party, any intermediate server that sees the aforementioned signaling sent into the network by server 13. The server which initiates the call to Smart Hold Content server 15 is, therefore, the server which effectuates the Smart Hold feature in accordance with the principles of the present invention. Illustratively, assume that server 14 acts as the Smart Hold feature server in accordance with the illustrative embodiment of the present invention shown in FIG. 1.

At this point, the Smart Hold feature server (illustratively, server 14) connects the call leg that is connected with Smart Hold Content server 15 to the held party call leg (e.g., the connection between telephone 12 and server 14). In this manner, the held party is advantageously now able to interact with Smart Hold Content server 15 (hereinafter, the “Content Server”). The Content Server may authenticate the identity of the user (unless, for example, it already knows the user's identity based on what it was told by the Smart Hold feature server). The Content Server then advantageously provides the appropriate personalized audio content for the user, based on a user profile for the given user. This profile may, for example, have been previously stored in a database associated with the Content Server. The personalized audio content may, for example, comprise relevant weather reports, traffic reports, news, stock quotes, etc.

At some later time, the holding party decides to take the call off hold, and may, for example, press a button on telephone 11 (e.g., the “hold” button again), or, alternatively, presses an appropriate key sequence on telephone 11. This signals the server closest to the holding party (i.e., server 13) that the call is now to be taken off hold. Server 13 (i.e., the server closest to the holding party) then advantageously propagates signaling information that the call is now off hold towards the held party server (i.e., server 14), which, in turn, may notify telephone 12 that it is being taken off hold.

At this time, the Smart Hold feature server (illustratively, server 14) advantageously signals Smart Hold Content server 15 that the hold is ending. In response, Smart Hold Content server 15 may advantageously play an alert tone into the existing connection between Smart Hold Content server 15 and telephone 12 (i.e., the phone of the held party), to alert the held party that the hold is ending. The Smart Hold feature server (illustratively, server 14) then advantageously re-connects the call leg from telephone 12 (i.e., the held party) to the call leg from telephone 11 (i.e., the holding party).

The initiator of the hold (i.e., the user of telephone 11) can now speak into his or her phone (i.e., telephone 11) to confirm that the held party is still on the line, and the two parties may then resume the conversation from where it had left off.

FIG. 2 shows an illustrative Voice-over-IP (Internet Protocol) communications network for realizing an alternative illustrative embodiment of the present invention. The illustrative network shown in the figure comprises VoIP (Voice-over-Internet Protocol) telephones 21 and 22, SIP (Session Initiation Protocol) servers 23, 24 and 25, which may, for example, comprise conventional VoIP Internet routers, and Smart Hold Content server 26, which comprises an application server and may, for example, hold various VoIP telecommunications feature specific content. (Note that, in general, there may be numerous additional SIP servers located in the path between telephone 21 and telephone 22.) Specifically, with reference to FIG. 2, the following process, similar to that described with reference to FIG. 1, may be employed to advantageously effectuate the alternative illustrative embodiment of the present invention.

First, a user of VoIP telephone 21 (hereinafter, the “holding party”), who wishes to place the call on hold, first tells the other party, a user of VoIP telephone 22 (hereinafter, the “held party”), that he is going to place the call on hold. The user that wants to initiate the hold (i.e., the user of VoIP telephone 21 or the holding party) presses the “Hold” button on VoIP telephone 21 (or, alternatively, presses an appropriate key sequence on VoIP telephone 21) to effectuate the hold. This advantageously signals to SIP server 23 that the user of VoIP telephone 21 wishes to place the current call on hold.

Next, SIP server 23 (i.e., the server closest to the holding party) signals into the network that the call is to be placed on hold. This signaling illustratively makes its way through SIP server 24 and, in particular, to SIP server 25 (i.e., the server closest to the held party), which may, for example, notify the held party (i.e., the user of VoIP telephone 22) that the call is being placed on hold.

In accordance with the principles of the present invention, and specifically in accordance with the alternative illustrative embodiment thereof, one of the SIP servers in the network “along the way” (e.g., in the network path from the holding party to the held party) initiates a call to Smart Hold Content server 26. The server which initiates this call may, for example, be SIP server 23 (i.e., the server closest to the holding party), SIP server 24, SIP server 25 (i.e., the server closest to the held party), or, in illustrative networks in which there are yet additional intermediate servers between the server closest to the holding party and the server closest to the held party, any intermediate server that sees the aforementioned signaling sent into the network by SIP server 23. The server which initiates the call to Smart Hold Content server 26 is, therefore, the server which effectuates the Smart Hold feature in accordance with the principles of the present invention. Illustratively, assume that SIP server 25 acts as the Smart Hold feature server in accordance with the alternative illustrative embodiment of the present invention shown in FIG. 2.

At this point, the Smart Hold feature server (illustratively, SIP server 25) connects the call leg that is connected with Smart Hold Content server 26 to the held party call leg (e.g., the connection between VoIP telephone 22 and SIP server 25). In this manner, the held party is advantageously now able to interact with Smart Hold Content server 26 (hereinafter, the “Content Server”). The Content Server may authenticate the identity of the user (unless, for example, it already knows the user's identity based on what it was told by the Smart Hold feature server). The Content Server then advantageously provides the appropriate personalized audio content for the user, based on a user profile for the given user. This profile may, for example, have been previously stored in a database associated with the Content Server. The personalized audio content may, for example, comprise relevant weather reports, traffic reports, news, stock quotes, etc.

At some later time, the holding party decides to take the call off hold, and may, for example, press a button on VoIP telephone 21 (e.g., the “hold” button again), or, alternatively, presses an appropriate key sequence on VoIP telephone 21. This signals the server closest to the holding party (i.e., SIP server 23) that the call is now to be taken off hold. SIP server 23 (i.e., the server closest to the holding party) then advantageously propagates signaling information that the call is now off hold towards the held party server (i.e., SIP server 25), which, in turn, may notify VoIP telephone 22 that it is being taken off hold.

At this time, the Smart Hold feature server (illustratively, SIP server 25) advantageously signals Smart Hold Content server 26 that the hold is ending. In response, Smart Hold Content server 26 may advantageously play an alert tone into the existing connection between Smart Hold Content server 26 and VoIP telephone 22 (i.e., the phone of the held party), to alert the held party that the hold is ending. The Smart Hold feature server (illustratively, SIP server 25) then advantageously re-connects the call leg from VoIP telephone 22 (i.e., the held party) to the call leg from VoIP telephone 21 (i.e., the holding party).

The initiator of the hold (i.e., the user of VoIP telephone 21) can now speak into his or her phone (i.e., VoIP telephone 21) to confirm that the held party is still on the line, and the two parties may then resume the conversation from where it had left off.

Note that, in accordance with the illustrative embodiments of the present invention described above, the held party was connected to a content server that delivered audio content of the held party's choosing for the duration of the Hold. Clearly, it is preferable that the audio content being provided is readily interruptible, since the holding party may resume the call at any time. Illustratively, in accordance with various illustrative embodiments of the present invention, the content might comprise access to voice mail, spoken e-mail (provided, for example, with use of text-to-speech conversion systems), etc. Alternatively, in accordance with various other illustrative embodiments of the present invention, the content might comprise other (preferably interruptible) live, bidirectional calls.

And in accordance with still other illustrative embodiments of the present invention, the content might comprise various interactively chosen information. (For example, the content server might tell the held party to “press or say one for news, two for weather,” etc., and then provide the requested content dependent on the held party's response.) Moreover, in accordance with certain illustrative embodiments of the present invention, the content server may be advantageously designed to support persistence—that is, it would keep track of the selected information that was presented to the held party, so if the same party were put on hold again, it could, for example, continue where it left off, or alternatively, it could avoid repeating the same content.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

I claim:

1. A method for providing audio content during telephony hold in a telecommunications network, the method comprising the steps of:
receiving an indication that a call between a holding party and a held party is to be placed on hold;
identifying personalized audio content associated with said held party; and
connecting the held party to said personalized audio content while said call is on hold.

2. The method of claim 1 wherein said personalized audio content is provided by an application server.

3. The method of claim 1 wherein said step of identifying said personalized audio content comprises authenticating an identity of the held party.

4. The method of claim 1 wherein said step of identifying said personalized audio content comprises performing a database lookup in a file containing a plurality of user profile information.

5. The method of claim 4 wherein said file containing said plurality of user profile information is stored in an application server.

6. The method of claim 1 wherein said step of identifying said personalized audio content includes the step of receiving a selection request from the held party indicating which one of a plurality of dynamically selectable options for audio content is to be connected thereto.

7. The method of claim 6 wherein said step of identifying said personalized audio content further includes the step of providing to the held party, with use of an audio message, an identification of said plurality of dynamically selectable options for audio content, and wherein said selection request is received from the held party in response thereto.

8. The method of claim 1 wherein said telecommunications network comprises a conventional telephone network which comprises one or more telecommunications switches.

9. The method of claim 1 wherein said telecommunications network comprises a VoIP (Voice-over Internet Protocol) communications network which comprises one or more VoIP Internet routers.

10. The method of claim 9 wherein said one or more VoIP network routers use an SIP (Session Initiation Protocol) signaling protocol.

11. A telecommunications network server for use in providing audio content during telephony hold in a telecommunications network, the telecommunications network server comprising:
means for receiving an indication that a call between a holding party and a held party is to be placed on hold;
means for identifying personalized audio content associated with said held party; and
means for connecting the held party to said personalized audio content while said call is on hold.

12. The telecommunications network server of claim 11 wherein said personalized audio content is provided by an application server.

13. The telecommunications network server of claim 11 wherein said means for identifying said personalized audio content comprises means for authenticating an identity of the held party.

14. The telecommunications network server of claim 11 wherein said means for identifying said personalized audio content comprises means for performing a database lookup in a file containing a plurality of user profile information.

15. The telecommunications network server of claim 14 wherein said file containing said plurality of user profile information is stored in an application server.

16. The telecommunications network server of claim 11 wherein said means for identifying said personalized audio content includes means for receiving a selection request from the held party indicating which one of a plurality of dynamically selectable options for audio content is to be connected thereto.

17. The telecommunications network server of claim 16 wherein said means for identifying said personalized audio content further includes means for providing to the held party, with use of an audio message, an identification of said plurality of dynamically selectable options for audio content, and wherein said selection request is received from the held party in response thereto.

18. The telecommunications network server of claim 11 wherein said telecommunications network comprises a conventional telephone network which comprises one or more telecommunications switches.

19. The telecommunications network server of claim 11 wherein said telecommunications network comprises a VoIP (Voice-over Internet Protocol) communications network which comprises one or more VoIP Internet routers.

20. The telecommunications network server of claim 19 wherein said one or more VoIP network routers use an SIP (Session Initiation Protocol) signaling protocol.
